(19) United States
(12) Patent Application Publication
(10) Pub. No.: US 2009/0073065 A1
(43) Pub. Date: Mar. 19, 2009

(54) Tunable Dielectric Resonator Circuit

(75) Inventor: David Frederick Jordan, Danville, MA (US)

Correspondence Address: TYCO TECHNOLOGY RESOURCES, 4550 NEW LINDEN HILL ROAD, SUITE 140, WILMINGTON, DE, 19808-2952, US

(73) Assignee: M/A-Com, Inc., Lowell, MA (US)

(21) Appl. No.: 11/855,431

(22) Filed: Sep. 14, 2007

(51) Int. Cl. H01Q 13/10

(52) U.S. Cl. 343/767

(57) ABSTRACT

An antenna comprising a layer of conductor having an edge, and a slot in the layer of conductor wherein conductor is absent, the slot having first and second opposing longitudinal ends and being opened to the edge at the first longitudinal end and not open to the edge at the second longitudinal end.

### FIELD OF THE INVENTION

The invention pertains to antennas.

### BACKGROUND OF THE INVENTION

Slot antennas are well-known in the art of wireless communications in both radiating (transmitting) applications, receiving applications, or both simultaneously. Any discussion of radiating or receiving in connection with antennas in this specification is merely exemplary. Throughout, this specification will discuss exemplary antennas in the context of radiating or transmitting. However it should be understood that the inventive antennas disclosed herein also could be used as receiving antennas and that, unless otherwise specified or obvious, the features, advantages, properties, etc. discussed herein in connection with a transmitting antenna are applicable (with proper modification for the inverse natures of receiving versus transmitting to use of the antenna as a receiving antenna.

Antennas of all types, including slot antennas, are commonly designed and used for their far field properties. While there is no well-accepted definition of far field, it generally refers to the field radiated by an antenna measured at a distance greater than one wavelength (of the center frequency of the antenna) from the antenna. Almost all of the literature on antennas pertains to their far field properties.

However, antennas also have near field radiation that is primarily or exclusively a magnetic field and which is different from its far field properties and that is largely ignored in the literature and in the design of antennas. Far field power attenuates at a rate of 1/r, whereas near field power attenuates at a rate of at least 1/r², where r is distance. Therefore, near field radiation typically is relevant only very close to the antenna. The near field radiated by an antenna essentially is primarily comprised of the magnetic flux generated around the antenna by the current running through the antenna.

Far field power attenuates at a rate of 1/r, where r is distance, whereas near field power attenuates at a rate of at least 1/r². Therefore, near field radiation is a localized phenomenon. Again, while there is no definitive, well-accepted definition of near field, it generally refers to the field within about 1 wavelength of the antenna center frequency.

Interest in the antenna industry lies almost exclusively in the far field properties of antennas because antennas are rarely used for transmitting over distances of less than one wavelength. For instance, the wavelength at 900 MHz, which is in the UHF (ultra high frequency) band, is approximately 13 inches.

Recently, the use of radio frequency identification (RFID) tags has increased dramatically. RFIDs are used, for example, in warehouses to track the location of goods. RFIDs basically are small circuits placed on or embedded into a product or, more commonly, in the box containing the product. A passive RFID tag basically comprising an antenna, a diode, and a digital circuit that can output a particular designated signal (the ID) to the antenna for radiating out to an RFID interrogator unit. Commonly, that ID signal is simply a number represented in PCM (pulse code modulation), FM (frequency modulation), or any other technique used for wireless transmissions. The number, for example, indicates that this is a box of 25 model G35 cellular telephones manufactured by XYZ Telephone Manufacturing Company. An RFID tag is interrogated by an interrogation unit that includes a transmitting antenna, a receiving antenna (which may be the same antenna as the transmitting antenna or a different antenna), circuitry for generating a signal to transmit to the RFID tags within range of the interrogation unit to wake them up to transmit their ID, and circuitry for reading the ID. More particularly, an antenna on the interrogation unit radiates energy within the bandwidth of the antenna of the RFID tag that is received by the antenna of the RFID tag and causes current to flow on the RFID antenna. The diode is coupled to the antenna of the RFID tag so that the current on the antenna flows to the diode. If the signal received from the interrogation unit is strong enough, it turns on the diode, which charges a capacitor. When the capacitor reaches a sufficient charge, it turns on the circuit causing it to output the ID signal to the RFID tag's antenna. The RFID tag antenna radiates the ID signal. The receiving antenna of the interrogation unit receives the ID signal, which signal is then sent to the reader circuit, which determines the ID. While RFID interrogation units usually are in used within a very close range for the RFID, they nevertheless still usually operate using the far field, rather than the near field.

### SUMMARY OF THE INVENTION

An antenna comprising a layer of conductor having an edge, and a slot in the layer of conductor wherein conductor is absent, the slot having first and second opposing longitudinal ends and being opened to the edge at the first longitudinal end and not open to the edge at the second longitudinal end.

### BRIEF DESCRIPTION OF THE DRAWINGS

FIG. 1 is a transparent perspective view of a grid antenna in accordance with a first embodiment of the present invention.

FIG. 2 is a plan view of the top surface of the grid antenna if FIG. 1.

FIG. 3 is a plan view of the bottom surface of the grid antenna of FIG. 1.

### DETAILED DESCRIPTION OF THE INVENTION

Antennas that use the near field radiation for communication as opposed to the far field radiation can be used for very close range wireless communication. Merely as one example, as RFID tags shrink in size, it is becoming practical to use very small RFID tags on individual products (rather than on a container or pallet containing many of the products). In such cases, it would be practical, and often desirable, to place the antenna of the interrogator unit very close to the RFID tag being inspected. It may be desirable, for instance, to read RFID tags on individual products, such as pharmaceutical bottles, in a store shelf environment where there are multiple pharmaceutical bottles positioned very close to one another. In such cases, it would be desirable for the interrogator unit antenna to work only over a very short range so as not to pick up the IDs from other nearby bottles or products, but only the one immediately in front of the antenna. Alternately, in other applications, it may actually be desirable to pick up the ID signals from multiple RFID tags in a particular volume of space.

In even other embodiments, it may be desirable to be able to interrogate RFID tags using both near field radiator and far field radiation.

All antennas, including antennas intended to operate only in the near field, radiate both near field and far field. Accordingly, even antennas designed to operate only in the near field, will generate far fields and care may need to be taken in connection with the design of the antenna and transmitter to assure that the far field properties of the antenna are carefully controlled. For instance, governments often promulgate regulations for wirelessly transmitted signals. For instance, the Federal Communications Commission (FCC) of the United States requires that radiating antennas used for RFID type systems have no more than 36 dBM of EIRP (Effective Isotopic Radiated Power). Since most transmitters transmit at about 30-31 dBM, antennas used with such transmitters can have a gain of no more than 5 or 6 dBM.

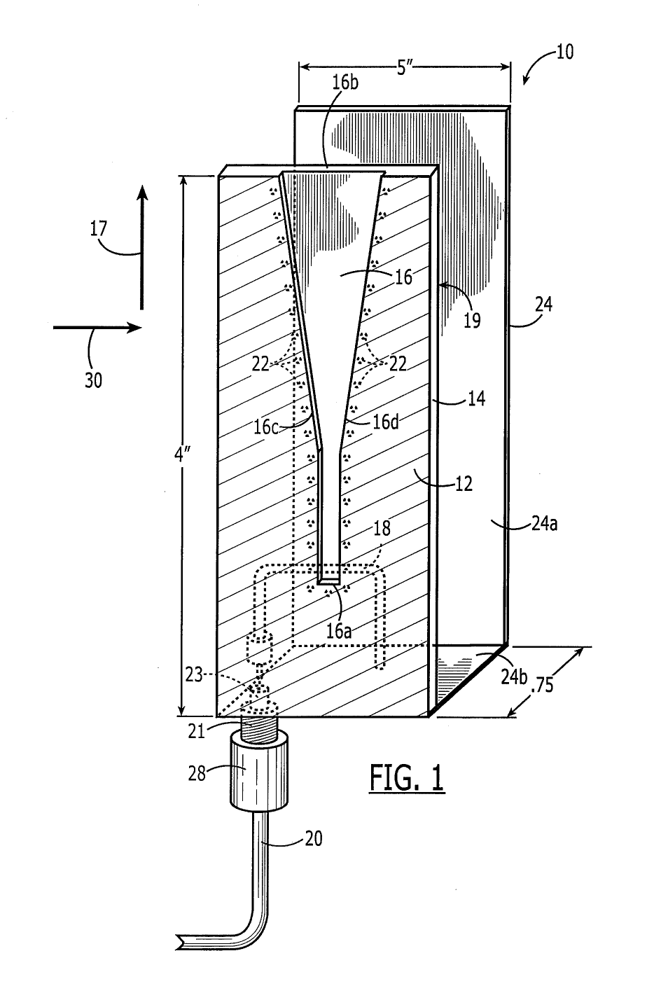

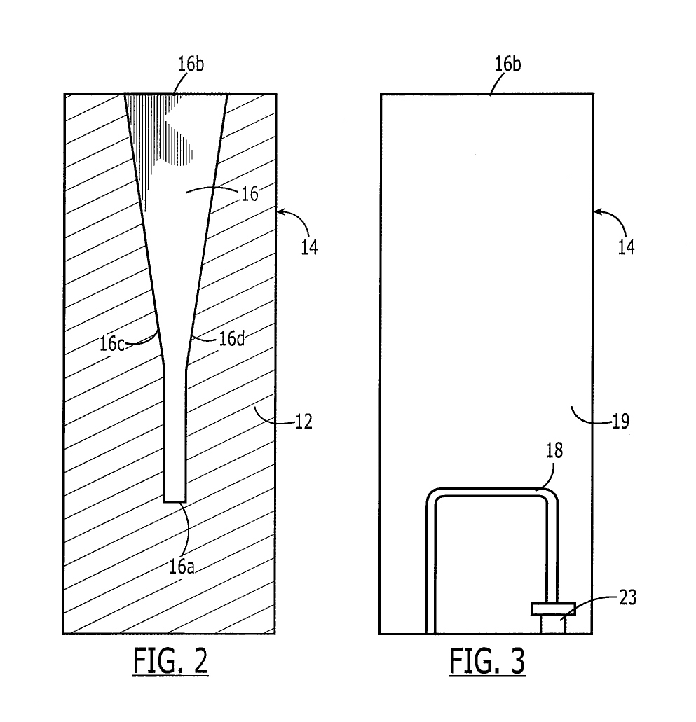

FIG. 1 is a transparent perspective view of an antenna 10 in accordance with a first embodiment of the present invention that can operate very well in the near field while also having reasonably good far field performance. FIG. 2 is a plan view of the top surface of the antenna and FIG. 3 is a plan view of the bottom surface of the antenna.

The antenna 10 is a slot antenna with the slot 16 open at one end. Particularly, a layer of conductor 12 includes the slot 16, which slot comprises a gap or area in the conductor in which conductor is absent. In the embodiment illustrated in FIGS. 1-3, the antenna is formed on a PCB substrate 14, such as FR-4. However, this is merely exemplary. Instead of FR-4 or another PCB material, the substrate can be ceramic. As another alternative, the antenna can be formed of a metal sheet with the slot punched out and a coaxial feed across the slot.

The top surface of the substrate 14 is covered with the conductive layer 12, which may be copper or another conductive metal, with the slot therein. The metal layer 12 is the ground plane of the antenna. In one embodiment, the metal is deposited on the PCB substrate by chemical vapor deposition (CVD) and the slot is etched into it using conventional photolithography techniques. However, all of this is merely exemplary and the antenna can be fabricated using entirely different materials and techniques.

For instance, alternately, the conductive layer and slot can be fabricated by stamping a slot into a piece of metal. In any event, the slot 16 has a longitudinal dimension (see line 17) with first and second longitudinal ends 16a, 16b and first and second longitudinal sides 16c, 16d. One end 16b of the slot is open to the edge of the conductive layer. The other end 16a is closed, i.e., it is surrounded by conductor. The particular dimensions of the slot will, of course, be dictated by the desired center frequency of the antenna. However, generally, the slots will have a length approximately equal to a quarter wavelength of the desired center frequency of the antenna and a width substantially less than its length. In the embodiment shown in FIGS. 1-3, the slot is straight for about the first third of its length from the closed longitudinal end 16a and is flared from about one third of the length from the closed longitudinal end 16a to the open end 16b. However, in other embodiments, the slot may be tapered the entire length of the slot or may be the same width over the entire length of the slot.

Tapering the slot increases its bandwidth. In the illustrated embodiments, the sides are tapered linearly.

The particular antenna shown in FIGS. 1-3 is designed to operate in a range of 902-928 MHz with a center frequency of about 915 MHz. In this example, the substrate 14 is approximately 3.5-4 inches long by approximately 1-1.5 inches wide with a thickness of approximately 0.31-0.62 inches. The slot is approximately 3.1 inches long with the flared portion being 2.0 inches long. The flare is at 13 degrees.

A feed structure is formed on the opposite side 19 of the substrate (although, in alternate embodiments, it could be formed on the same side of the substrate as the slot, as will be discussed below). In this embodiment, the feed structure is a microstrip 18 fed from the edge of the substrate. The microstrip 18 extends from the edge on one side of the slot parallel to the longitudinal dimension 17 of the slot, then turns orthogonal to the slot and crosses the slot orthogonally thereto. When the current in the micro strip crosses the discontinuity or gap of the slot (i.e. the transition from there being conductor above the microscope to there being no conductor above the micro strip and back to conductor again), the energy in the microstrip excites the gap which generates a voltage in the transverse direction across the gap, which generates current flow in the conductor.

The far field radiation excited in a slot antenna of the type of the present invention is polarized in the transverse direction across the slot as illustrated by arrow 30 in the Figures. The near field radiation, being primarily a magnetic field, does not have a polarization per se.

In one embodiment of the invention, the microstrip extends about a quarter wavelength past the slot, which allows for some tuning of the impedance of the antenna. The microstrip can be meandered as needed to provide the desired length. The end of the microstrip on the far side of the slot (the side opposite the signal source) essentially is an open circuited quarter wavelength transmission line. A quarter wavelength open circuit looks like a short circuit to the slot because it is resonant at the center frequency of the slot. By varying the length of the microstrip on the far end of the slot slightly more or less that ¼ wavelength, the antenna impedance can be tuned.

Alternately, the slot can be fed from a feed structure on the same side of the substrate. For instance, a coaxial cable can be coupled across the slot, for instance, with the outer conductor electrically connected to the conductive layer on one longitudinal side of the slot and the center conductor electrically connected to the conductive layer on the other longitudinal side of the slot.

In alternative embodiments, overlapping slots can be formed on opposite sides of the substrate 14. In such embodiments, both sides of the substrate would be covered with metal. Those two metal layers could be electrically connected to each other via plated through holes around the slot as shown in phantom in FIG. 1 so that they collectively form the ground plane of the antenna. The use of two overlapping slots on opposite sides of the substrate can be beneficial in terms of reducing dielectric losses.

The antenna can be coupled to a receiver, transmitter, or transceiver by any reasonable means. The Figures illustrate a coaxial cable 20 connected to an edge connector 23 on the substrate 14. The center conductor of the coaxial cable may be coupled to the ground plane 12 and the outer conductor coupled to the micro strip 18.

The antenna may be mounted on or near large conductive items, such as a pole or a piece of equipment with conductive circuitry, housings, etc. Therefore, it may be desirable to include a reflector 24 in the antenna design. The reflector 24 may comprise a sheet of conductor positioned generally parallel to the plane of the slot (although the slot and the conductive layer within which it is disposed need not necessarily be planar). The reflector serves one or more of several purposes. First, the reflector may shield the antenna from radiation from other equipment located behind the reflector that might otherwise affect the operation of the antenna. Second, the reflector may shield other equipment located behind the reflector from radiation from the antenna. Third, a relatively large conductive surface, such as the reflector, electrically coupled to the ground plane of the antenna would help set the ground plane conditions of the antenna, and particularly the impedance of the antenna. Specifically, if the antenna is designed with the reflector in mind, which is a large conductor in the vicinity of the slot, then subsequently mounting the antenna next to another large conductor, such as a pole or other equipment, would have very little effect on its ground plane conditions, since the antenna has already been designed to operate with a large conductor next to it.

Particularly, the reflector and ground plane help define the impedance of the antenna. It is important to accurately control the impedance of the antenna so as to match it with the impedance of the circuitry with which it will be used. Most antennas typically should have an impedance of about 50 to 70 ohms in order that they are impedance matched to conventional transmitters, receivers, and transceivers, which commonly have an impedance of 50 to 70 ohms.

The reflector 24 can be anything that reflects RF radiation. In one embodiment, the reflector is a brass plate. The plate may be formed in the shape of an L and attached to the ground plane at the end of the bottom segment of the L.

The cavity depth between the reflector and the slot can be relatively small. In the exemplary antenna operating with a center frequency of 912 MHz, it is about 0.75 inches. This gap can be made smaller by filling the gap with a high dielectric constant dielectric. However, in less demanding applications, the gap may be an air gap or may be filled with dielectric foam.

In certain applications, it may be desirable to employ a ferrite module 28 at the end of the feed cable 20 to choke off the flow of energy on the outside of the cable, known as common mode current flow, which might occur in the event of impedance mismatch between the antenna and the transmitter/receiver.

The slot antenna of the present invention radiates well in all directions in the near field. Particularly, it radiates from its longitudinal edges 16c, 16d as well as the open end 16b. Therefore, it can cover a reasonably large volume close to the antenna with near field energy. This makes it particularly suitable for use in an RFID tag interrogator.

Also, it has a far field gain of about 2 dBM. Therefore, it can be used with conventional transmitters, which usually have a gain of about 30-31 dBM, while remaining well within the 36 dBM requirements of the FCC for far field radiation.

In order to increase the volume covered by the radiation and/or to broaden the polarization range of the transmitted radiation or radiation that it can receive, two or more of these antennas can be used together, either on the same substrate or on different substrates. For instance, two such slots can be formed on a single substrate with their longitudinal directions oriented orthogonal to each other. This would provide polarization in two orthogonal directions. Two or more antennas can be positioned side by side in either the same orientation or in different orientations to increase the volume covered by the radiation pattern of the antenna.

While the antenna is particularly suited to transmit and/or receive near field, it can also adequately receive far field signals at greater distances. Therefore, the antenna can be used effectively in applications in which the ability to transmit and/or receive using both near field and far field is a desirable feature.

Having thus described a few particular embodiments of the invention, various alterations, modifications, and improvements will readily occur to those skilled in the art. For example, the mounting members may mount the resonators in a fixed position with tuning being fixed upon assembly or adjusted through the use of tuning plates and/or conductive members. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

We claim:

1. A near field antenna comprising:
a layer of conductor having an edge; and
a slot in the layer of conductor wherein conductor is absent, the slot having first and second opposing longitudinal ends and being opened to the edge at the first longitudinal end and not open to the edge at the second longitudinal end.

2. The antenna of claim 1 wherein the slot is tapered in the longitudinal direction along at least a portion thereof.

3. The antenna of claim 2 wherein the slot is widest at the first end.

4. The antenna of claim 2 wherein the slot is linearly tapered.

5. The antenna of claim 1 further comprising:
a feed line for coupling signal energy with the slot; and
a dielectric between the feed line and the layer of conductor.

6. The antenna of claim 5 wherein the slot further comprises longitudinal sides and wherein the slot radiates out of its longitudinal ends and its longitudinal sides.

7. The antenna of claim 5 further comprising a reflector adjacent to the layer of conductor.

8. The antenna of claim 7 wherein the reflector is substantially parallel to the slot.

9. The antenna of claim 7 wherein the reflector comprises a conductive layer positioned on the same side of the layer of conductor as the feed line and wherein the feed line is between the reflector and the conductive layer.

10. The antenna of claim 5 wherein the feed line is a microstrip.

11. The antenna of claim 5 wherein the dielectric is a substrate, the layer of conductor is disposed on a first side of the substrate and the feed line is disposed on a second, opposing side of the substrate.

12. The antenna of claim 1 wherein the antenna is a near field antenna for at least one of radiating and receiving a near field signal.

13. The antenna of claim 12 wherein the antenna has a center frequency and is a near field antenna for at least one of radiating and receiving a near field signal within a distance of less than about one wavelength of the center frequency of the antenna.

14. An RFID interrogation unit comprising the antenna of claim 1.
